(19) United States
(12) Patent Application Publication
(10) Pub. No.: US 2010/0218707 A1
(43) Pub. Date: Sep. 2, 2010

(54) RECEIPTING AND DISPENSING BANKNOTE MODULE FOR EQUIPMENTS OF AUTOMATIC DEPOSIT AND WITHDRAWL OF BANKNOTES

(75) Inventors: Mirko Billet, Bollengo (IT); Mauro Martinotti, Bollengo (IT); Mario Perino, Bollengo (IT); Renato Bortolin, Bollengo (IT); Carlo Simonotti, Bollengo (IT); Ivan Ferrero Aprato, Bollengo (IT)

Correspondence Address: SUGHRUE MION, PLLC, 2100 PENNSYLVANIA AVENUE, N.W., SUITE 800, WASHINGTON, DC, 20037, US

(73) Assignee: CTS CASHPRO S.P.A., Bollengo (IT)

(21) Appl. No.: 12/681,316

(22) PCT Filed: Oct. 1, 2008
(86) PCT No.: PCT/IB08/54537

§ 371 Date: Apr. 1, 2010

(30) Foreign Application Priority Data
Oct. 12, 2007 (IT) TO2007A000723

(51) Int. Cl. G07D 11/00; E05G 1/06

(52) U.S. Cl. 109/53; 232/1 D

(57) ABSTRACT

Receipting and dispensing module (32-1) for equipments of automatic deposit and withdrawal of banknotes including a banknote seat (234) for storing banknotes (32) with arrangement in superimposition and subdivision in two banknote stacks (238f and 238r) and a couple of insertion and extraction devices (241f and 241r) for the insertion and the extraction of the banknotes. The banknote seat (234) is usable by each banknote stack and the insertion and extraction devices are arranged at the ends of the banknote seat. The module (32-i) comprises an input-output passage (82) and a diverting member (246) controllable for causing the banknotes to transit between the input-output passage (82) and one or the other insertion and extraction device. Guiding and moving elements (247) are provided for guiding and moving the banknotes between the diverting member (246) and one (241r) of the insertion and extraction devices (241f and 241r).

### FIELD OF THE INVENTION

The present invention relates to a banknote receipting and dispensing module for an equipment of automatic deposit and withdrawal of banknotes.

More specifically, the invention relates to a banknote receipting and dispensing module or box for equipments of automatic deposit and withdrawal of banknotes and a respective equipment of automatic deposit and withdrawal of banknotes according to the introductory portions of the main claims.

### BACKGROUND OF THE INVENTION

Equipments for the automatic deposit and withdrawal of banknotes are used in banking sites, as help for tellers or as “self service” equipments operable by customers, for banking transactions comprising the deposit and the withdrawal of cash. These equipments provide banknote receipting and dispensing modules or boxes, having function of recycling, mountable with possibility of replacing in respective housings, and in which each module or box is provided of a seat associated to a given typology of banknotes. For high storing capacity, modules or boxes are often preferred in which the banknotes are arranged as a stack with horizontal extension and support on a longer edge.

The number of employed housings and modules or boxes determines denominations and/or typologies of the banknotes to be handled, as well as dimensions and cost of the equipment. Therefore, in the case of vertically overlapped boxes, the number of the housings affects the overall height of the equipment. As an example, an equipment which proposes to recycle banknotes of the EURO system should provide seven modules or boxes, respectively, for the denominations of: 5, 10, 20, 50, 100, 200 and 500 Euro, and seven respective housings.

In the use, the boxes associated with the denominations or typologies of banknotes of reduced circulation, for instance the boxes for banknotes of 200 and 500 Euro, are generally subject to a limited number of storage and dispensing operations, for small quantities and reduced occupation of the seats. On the contrary, the boxes lodging the denominations of banknotes of greater circulation, for instance banknotes of 20 and 50 Euro, should satisfy high requests of storage and dispensing, often varying in the time.

The room provided in the equipment for the deposit of banknotes is therefore used in a non optimal way. Moreover, the boxes for the banknotes of greater circulation can easily reach the conditions of full box or empty box and blocking of the equipment: The emptying and recharging operations of the boxes should be frequent with increasing of the overheads. On the other hand, the addition of housings for the boxes of banknotes with greater circulation is expensive and it is often impracticable in view of current rules on the limits of height of the equipments.

Banknote processing equipments are known which use double modules for the deposit and the automatic withdrawal of banknotes, with function of recycling. These modules include a banknote seat with arrangement of the banknotes in superimposition and subdivision in two banknote stacks, and a couple of insertion and extraction devices. The stacks occupy together the banknote seat; the insertion and extraction devices are adjacent to terminal sections of the seat and insert and extract the banknotes by means of the transport mechanisms of the equipment. The room of the banknote seat is used in optimized way, but the equipment should provide, by opposite sides of the housings, two transport mechanisms for the two stacks of banknotes of the common seat. It creates problems of access in one or in both transport mechanisms, when an inspection is necessary or in the case of jam of the banknotes in movement.

### SUMMARY OF THE INVENTION

An object of this invention is to accomplish a receipting or dispensing module or box for equipments of automatic deposit and withdrawal of banknotes which allows to process two different typologies of banknotes, which results reliable, of relatively contained cost, and in which the operations on the modules or boxes are easy.

According to a characteristic of the present invention, the banknote receipting and dispensing module is employable in an equipment for the deposit and the withdrawal of banknotes and includes a banknote seat for storing banknotes with arrangement in superimposition and subdivision in two banknote stacks along a given stacking direction and a pair of insertion and extraction devices for the insertion and the extraction of the banknotes. The banknote seat is usable by each one of the stacks and the insertion and extraction devices are arranged at the ends of the seat. The module includes: a single input-output passage for the banknotes regarding the two stacks; and a diverting member controllable for making the banknotes to selectively transit between the input-output passage and the one or the other insertion and extraction device. Guiding and moving elements are provided for guiding and moving the banknotes between the diverting member and at least one of the insertion and extraction devices.

According to another characteristic, a double box includes a reference surface for the stacks of banknotes in vertical and supporting belts, associated with each one of the two stacks, projecting of a little with respect to the reference surface. The supporting belts of a given stack extend from the pressing element to a respective terminal section of the seat, returning toward the other terminal section and in which each belt has an end fixed to the pressing element and an opposite end arranged underneath the reference surface. Restoring members are provided for maintaining in tension the belts during the movement of the pressing elements.

Further, according to another characteristic, the banknote stacks have vertical arrangement with support of the banknotes on the longer edges and a double box comprises a pair of pressing elements to push, in independent way, the banknote stacks against the insertion and extraction devices. The pressing elements include respective carriages having a moving member on board and specular configuration for minimum dimensions in condition of maximum filling of the banknote seat.

### BRIEF DESCRIPTION OF THE FIGURES

The characteristics of the invention will become clear from the following description given purely by way of non-limiting example, with reference to the appended drawings in which:

FIG. 1 represents a schematic lateral view of an equipment for deposit and automatic withdrawal of banknotes and respective receipting or dispensing modules or boxes according to the invention, in condition of use;

FIG. 2 shows a schematic lateral view, partial, of the equipment and the modules or boxes according to the invention, in a condition of service;

FIG. 3 is a schematic perspective view of a banknote receipting and dispensing box according to the invention;

FIG. 4 represents a schematic lateral section of the module or box of the invention in a given operational condition;

FIG. 5 shows a partial scheme of a device employed by the module or box of the invention in the operational condition of FIG. 4;

FIG. 6 represents a schematic lateral section of the module or box of FIG. 4, in another operational condition;

FIG. 7 shows a partial scheme of a device employed by the module or box of the invention in the operational condition of FIG. 6;

FIG. 8 is a schematic perspective view of internal components of the banknote receipting and dispensing box according to the invention;

FIG. 9 shows a partial schematic lateral section of the module or box of the invention;

FIG. 10 represents a partial schematic lateral section of some components of the module or box of the invention;

FIG. 11 is a perspective view from the bottom of some components of the module or box of the invention in a given condition of service;

FIG. 12 is a perspective view from the top of some components of the module or box in the condition of service of FIG. 11;

FIG. 13 is a plan view of some components of the module or box of the invention;

FIG. 14 represents a partial schematic lateral section of further components of the module or box of the invention; and

FIG. 15 is a view from the bottom of some components shown in FIG. 14.

### DETAILED DESCRIPTION OF THE PREFERRED EMBODIMENTS

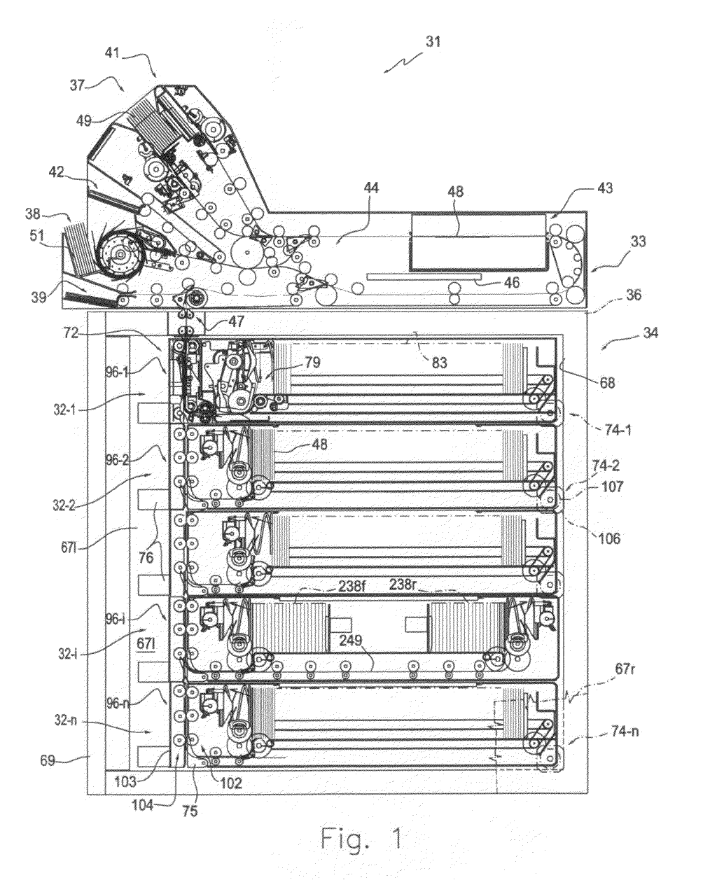

The FIG. 1 represents, in schematic shape, an equipment 31 for the deposit and the automatic withdrawal of banknotes, with a series of receipting or dispensing modules or boxes 32-1, 32-2, . . . , 32-n, from now onwards defined as receipting and dispensing boxes, of the type described in the Italian Patent Application TO2007A000721, filed on Dec. 10, 2007 in the name of the Applicant CTS Cashpro S.p.A. and whose contents are included, as reference, in the present description. The herein described and represented components maintain the same numeration of the components with identical functionality of the cited application TO2007A000721.

The equipment 31 includes, vertically overlapped, an upper body 33 and a lower body 34: The upper body is of interface for the operator, while the lower body is defined by a store-safe 36 in which the boxes 32 1, 32 2, . . . , 32-n are mounted. The equipment 31 can process flexible documents different by the banknotes, as checks and notes. Anyway, from now onwards, the term banknotes will also designate these flexible documents. The boxes include the box 32-i, similar to the other boxes 32 1, 32 2, 32n but having components and functions specific of the present invention.

The upper body 33 includes, in a conventionally frontal portion, an input port 37 for depositing and introducing the banknotes, an output port 38 for their dispensing, a forgery vane 39, a deposit rejection vane 41 and a withdrawal rejection vane 42. The input port 37 and the output port 38 are open and are accessible to the user, while the vanes 39, 41 and 42 are accessible through keys. Moreover, are in evidences inside the body 33: a validation device 43 in a rear portion, an interface transport mechanism 44, an electronic control unit 46 and an input-output port 47, of connection with the store-safe 36.

The input port 37 and the output port 38 are provided for receiving banknotes introduced by the user as a deposit stack 49 and, respectively, for receiving the banknotes requested by the user as a withdrawal stack 51. The forgery vane 39 receives the banknotes suspect of forgery, the deposit rejection vane 41 is provided for receiving the components of the stack 49 rejected by the equipment 31 in phase of deposit, while the withdrawal rejection vane 42 normally receives the banknotes discarded by the equipment in the phase of withdrawal. The interface transport mechanism includes passive diverters and controlled diverters to connect the transaction ports and the vanes banknotes with the validation device 48 and with the input-output port 47.

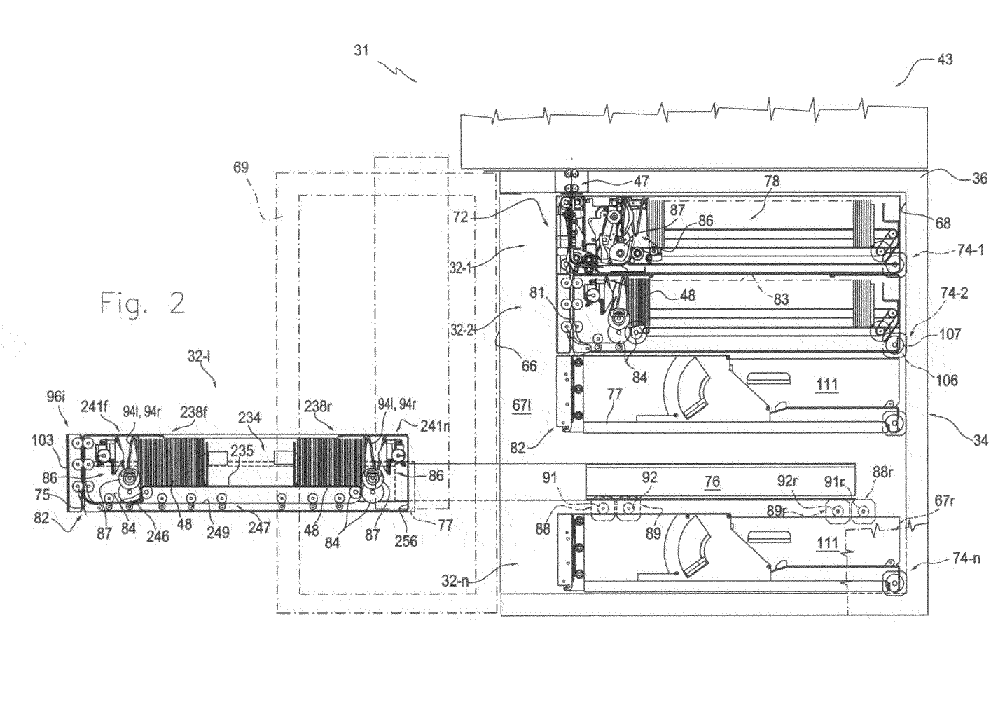

The store-safe 36 has a front opening 66, side walls 67l and 67r, a rear wall 68, a door 69 for the opening 66 and a plurality of housings for the boxes 32-1, 32-2, . . . , 32-i, 32-n. In the store-safe 36 are mounted a store transport mechanism 72, a transport moving member for the store transport mechanism and a plurality of stacking moving members 74-1, 74-2, . . . 74-n (FIG. 2) for the boxes 32-1, 32-2, . . . , 32-n.

In the store-safe, the housings for the boxes are arranged in vertical on a column and lodge each one a respective box 32. The store transport mechanism 72 has substantially vertical path and comprises diverting members 75 for the boxes 32. Through the diverting members, the transport mechanism 72 moves the banknotes 48 between the door 47 and the boxes 32. The door 69 has a safety lock, not shown in the figures, and it makes to access to the transport mechanism 72 and the boxes 32-1, 32-2, . . . , 32-i, 32-n.

Respective guides 76 are mounted on the walls 67l and 67r in the space provided for the housings of the boxes and support the boxes 32-1, 32-2, . . . , 32-i, 32-n (FIG. 2) through trays 77 slidable in horizontal between an operational position (boxes 32-1, 32-n) and a position of service (box 32-i). The operational position is inside the store-safe 36 and is functional to each box 32 for the reception and withdrawal of the banknotes 48. The position of service of the boxes is external to the store-safe 36, for an arrangement of the single boxes 32 countlever through the opening 66 and it is functional to each box for operations on the banknotes 48 associated to the emptying and the recharging and for maintenance.

The boxes 32-1, 32-2, . . . , 32-i, 32-n have dimensions and functionality similar to the dimensions and the functionality of the boxes for deposit and withdrawal of banknotes described in the Italian Patent Application TO2006A00094 filed on Oct. 2, 2006 in the name of the Applicant CTS Cashpro S.p.A. and whose contents are herein included as reference. The boxes 32-1, 32-2, . . . , 32-i, 32-n have substantially parallelepiped shape, lengthened in depth, and generically present a seat 78 for the banknotes 48 and an insertion and extraction device 79. Each box 32 shows a bottom, and a front wall 81 with an opening 82, adjacent to the bottom, of passage for the banknotes in input or in output. The banknotes 48 are arranged in vertical according to a stack 83, with extension overposed in horizontal.

In synthesis, the insertion and extraction device 79 (FIG. 5) of each box 32 includes introduction-extraction rollers 84 for the introduction and the extraction of the banknotes, a separation member 86 for making easier the introduction of the banknotes and a separation roller 87 for the unstacking operation of the banknotes from the stack 83. The rollers 84 are arranged of few underneath the collecting seat 78 provided for the stack 83, while the separation member 86 is interposed between the input-output opening 82 and the stack of banknotes 83. The separation roller 87 is connected in the rotation, in synchronous way, with the introduction-extraction rollers 84, through a pulley and toothed belt coupling. The separation member 86 is shiftable between an operational position, downstream of the separation roller 87 in the sense of the stacking, for a configuration of deposit of the banknotes and a non-operational position, upstream of the separation roller and as represented for the box 32-2 (FIG. 2), in connection with a configuration of dispensing.

Respective configuration motors 88 (FIGS. 2 and 5) operate on the separation member 86 to motorize the single boxes 32-1, 32-2, . . . , 32-1, 32-n, while introduction-extraction motors 89 actuate the rotation of the introduction-extraction rollers 84. The motors 88 and 89 are mounted on the wall 67r of the store safe 36 and comprise respective driving gears 91 and 92 projecting from the wall 67l in correspondence of the housings for the boxes. In the operational position of the boxes 32, the driving gears 91 and 92 engage taking gears 90 and 93 for the separation member 86 and, respectively, for the introduction-extraction rollers 84 and for the separation roller 87. The introduction of the banknotes 48 is associated to a given sense of motion of the motor 89, while the extraction is associated to an opposite sense of motion. The stack of banknotes 83 of each box is moved jointly to the introduction and the extraction of the banknotes by means of a pressing element actuated by a respective member of motorization.

Similarly to what described in the cited Italian Patent Application TO2006A00094, the separation member 86 for each box 32 includes two insertion spiral elements for banknotes, represented with 94l and 94r, extended in the sense of the stacking, for overposing the banknotes to be deposited on a terminal surface of the stack 83: The spirals 94l and 94r are rotated by the driving gear 91 of the respective motor 88, through the taking gear 90 (FIG. 5) and a kinematic chain comprising pulleys and toothed belts 95-1, a shaft 95-2 and conic gears 95-3.

The spirals 94l and 94r are mounted on a carriage 95-4, which also supports the conic gears 95-3. The carriage 95-4 is moved between the operational position of the spirals 94l and 94r and the non-operational position (FIG. 7), on control of a cyclic actuation mechanism represented with 100 and described in the cited Patent Application TO2006A00094. The mechanism 100 is sensitive to the change of the sense of rotation of the introduction-extraction motor 89 and is actuated by the same motor 89 and the stacking moving member of the pressing element of the stack 83.

In the operational position, the spirals 94l and 94r (FIG. 5) are in contact with the stacking surface of the stack of banknotes 83 and the insertion of the banknotes 48 occurs from the bottom upwards by means of the introduction-extraction rollers 84. The spirals 94l and 94r are rotated by the respective configuration motor 88 in synchronism with the movement of the entering banknotes so that the same banknotes are received, with a pre-defined phase, between the coils and are overlapped on the stacking surface. The stacking of the banknotes is rendered easier by shovel elements 116 rotatable in synchronism with the spirals 94l and 94r.

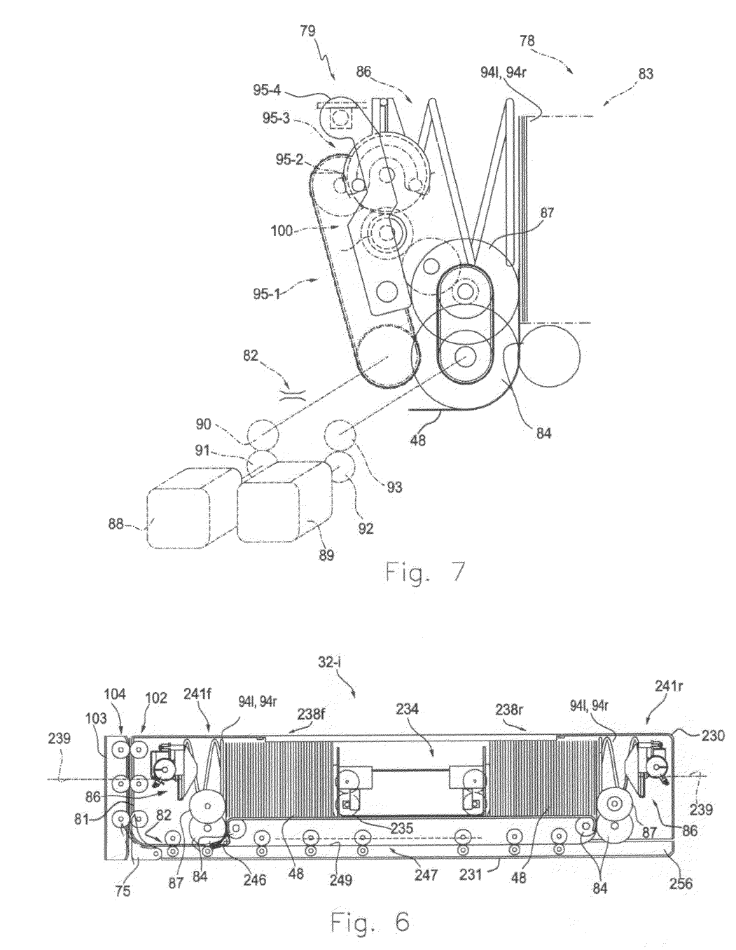

In the non-operational position of the spirals 94l and 94r (FIG. 7), the stacking surface of the stack of banknotes 83 is in contact with the separation roller 87. The respective introduction-extraction motor 89 make the roller 87 to rotate through the taking gear 93 and a kinematic chain comprising pulleys and toothed belts, extracting the banknotes 48 by the stack 83 from the top downwards. Then, the extracted banknotes are moved toward the diverting member 75 (FIGS. 2 and 6) and the transport mechanism 72, by means of the introduction-extraction rollers 84.

The store transport mechanism 72 (FIGS. 1 and 2) of the equipment 31 has individual sections 96-1, 96-2, 96-i,. . . 96-n, associated with the single boxes 32-1, 32 2, . . . , 32-i, 32-n, and mounted on the same boxes. These sections 96-1, 96-2, . . . , 96-i, 96-n are moved together with the boxes 32-1, 32-2, . . . , 32-i, 32-n in the positions of service and have possibility of access to corresponding fractions of the banknote path between the boxes and the input-output port 47. The individual sections 96-1, 96-2, . . . , 96-i, 96-n take the motion or directly through the member of motorization 73, or from another of the individual sections. The respective diverting members 75 are also mounted on the boxes 32, adjacent to the opening 82.

The transport moving member 73 includes a transport motor and a motor pinion, not shown, mounted in the store safe 36. The individual sections 96-1, 96-2, . . . , 96-i, 96-n include each one one a taking gear in an upper portion of the box 32 and, in a lower portion, a transmission gear, which is connected in the rotation with the taking gear. In the operational position of the boxes 32, the sections 96-1, 96-2, . . . , 96-i, 96-n take the motion or by the motor pinion or by the transmission gear of the upper section, while these sections are disengaged by the transport mechanism in the positions of service of the boxes.

The individual sections 96-1, 96-2, . . . , 96-i, 96-n include each one a series of box transport rollers 102 supported in the rotation by the front wall 81, a frame 103 fulcrumed in correspondence of the passage opening 82 of the box 32 and a series of counter rollers 104 supported in the rotation by the frame 103. The transport rollers 102 are connected in the rotation with the taking gear of the box. The frame 103 is shiftable between a position of transport, adjacent to the wall 81 and in which the counter-rollers 104 oppose the transport rollers 102 and a position of access in which the counter-rollers 104 are spaced away from the rollers 102.

In the position of transport of the frame 103 and for the operational position of the box 32, the box transport rollers 102 and the counter-rollers 104 define fractions of path and shifting of the banknotes in front of the boxes 32-1, 32-2, . . . , 32-i, 32-n, together with corresponding guide elements of known type. Under these conditions, a banknote in movement along this fraction of the section 96-1, 96 2, . . . , 96-i, 96-n can proceed toward the upper or lower box 32 or be deviated toward the banknote seat 78 by means of the member 75. Likewise, a banknote 48 emerging from the box 32 can be deviated by the member 75 toward the rollers 102 and the counter-rollers 104 along the fraction of the section 96-1, 96-2, . . . , 96-i, 96-n and toward the opening 82. In the position of service of the box 32, the frame 103 can be moved away from the wall 81 for the possible removal of banknotes clogged in the section 96-1, 96-2, . . . , 96-i, 96-n and in condition of liberty of the transport rollers and the diverting member 75.

The boxes 32-1, 32-2, . . . , 32-n, for instance the box 32n, can be of removable type, as described in the cited Patent Application TO2007A000721, comprising a base structure 109 and a recycling container 111. in which is defined the seat 78 for the banknotes 48. The container 111 is mountable and removable with respect to the structure 109 and it is coupable with respect to the insertion and extraction device 79 of the box. The device 79 interfaces the transport mechanism 72, while the box 111 is engageable with the stack 83 for entering the banknotes in the box and, in alternative, for singularly extracting the banknotes. The container 111 is removable from the insertion and extraction device 79 and it is coupable with the device 79 in the position of service of the respective box 32.

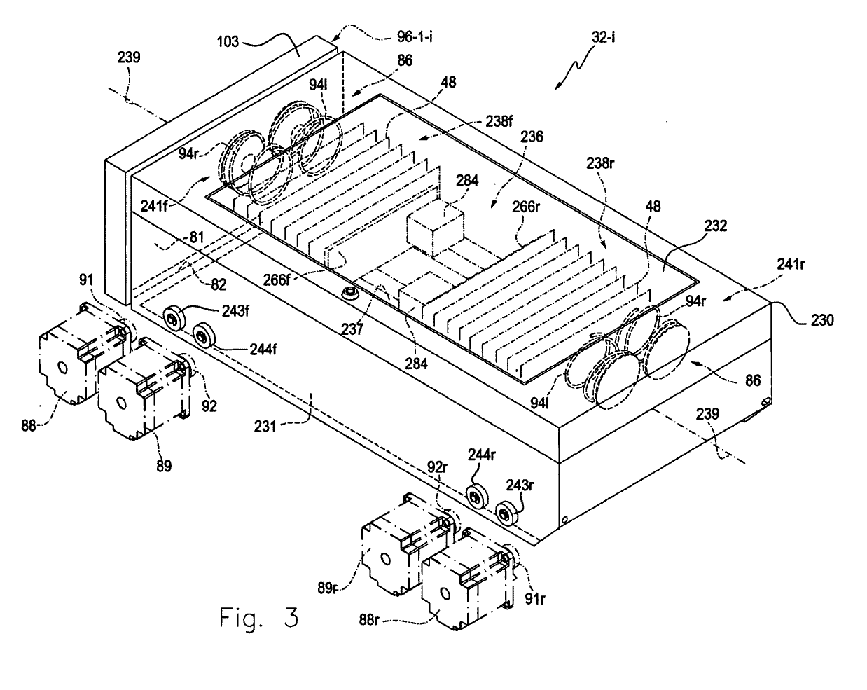

According to the invention, the box 32-i comprises an envelope 230 (FIGS. 3, 4 and 6), of lengthened substantially parallelepiped shape, which frontally supports the individual section 96-i of the transport mechanism store 72 and the diverting member 75 and includes a bottom 231 and the front wall 81, and in which the opening 82 is arranged on the wall 81, adjacent to the bottom 231. The envelope 230 is provided of a cover 232 with lock, and internally has a frame 233 (FIGS. 3, 4, 6, 8, 9), with a banknote seat, herein represented with 234. The seat 234 is of lengthened substantially parallelepiped shape, horizontal in the use, open at the front and back ends, and which is delimited in a lower part by a plate of base 235 and laterally by two walls 236, and with two terminal sections 237f and 237r. The plate of base 235 defines a reference surface for the seat 234, of a little above the diverting member 75 and the opening 82.

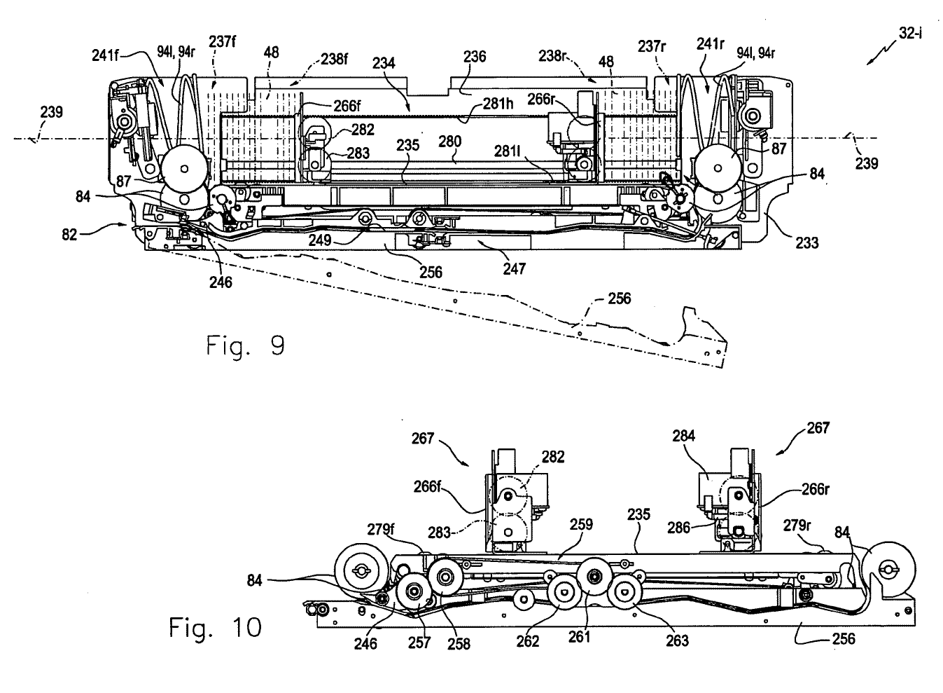

The box 32-i stores, in the seat 234, banknotes 48 (FIGS. 3 and 9) of two different typologies, arranged in vertical and support on the longer edge. The banknotes are divided in two banknote stacks 238f and 238r, similar to the stacks 83 of the other boxes 32, arranged one behind the other along a common horizontal stacking direction 239. The stacks 238f and 238r define respective insertion and unstacking surfaces adjacent to the terminal sections 237f and 237r and have possibility of use of the whole useful space of the seat 234 between the terminal sections 237f and 237r. The frame 233 supports in the front and the back a pair of insertion and extraction devices 241f and 241r, and in which the device 241f is adjacent to the opening 82.

Thus, the insertion and extraction devices 241f and 241r are arranged in correspondence of the terminal sections 237f and 237r and provide to the orderly stacking of the banknotes on the insertion and unstacking surfaces of the stacks 238f and 238r and to the unstacking operation. The devices 241f and 241r are identical each the other and similar to the above described insertion and extraction device 79. Specifically, each device 241f, 241r includes the introduction-extraction rollers 84 for moving the entering banknotes and the emerging banknotes, the separation member with the spiral elements 94l, 94r for stacking the entering banknotes, the separation roller 87 for separating the stacked banknotes and the cyclical actuating mechanism 100 (See FIG. 7) for modifying the configuration of the spiral elements 94l, 94r between deposit and dispensing. The shovel elements 116 are also included, in correspondence of the terminal sections 237f and 237r for making easier the stacking of the banknotes.

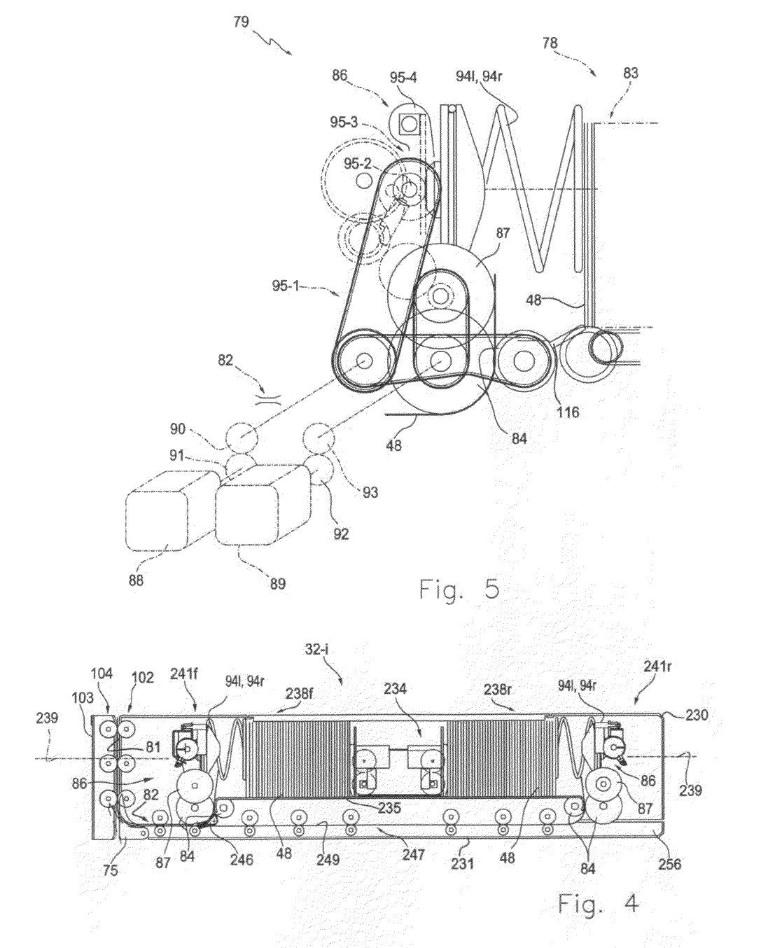

In each stack 238f, 238r, the cyclical actuating mechanism 100 moves the spiral elements 94l, 94r between the operational position, downstream of the separation roller 87 in the sense of the stacking, for the configuration of deposit and a non-operational position, upstream of the separation roller, for the configuration of dispensing. In the condition of deposit (FIGS. 4 and 5), the banknotes enter through the opening 82 and are stored, with stacked arrangement, in the seat 234. In the condition of dispensing (FIGS. 6 and 7), the stacked banknotes are separated and emerge from the opening 82.

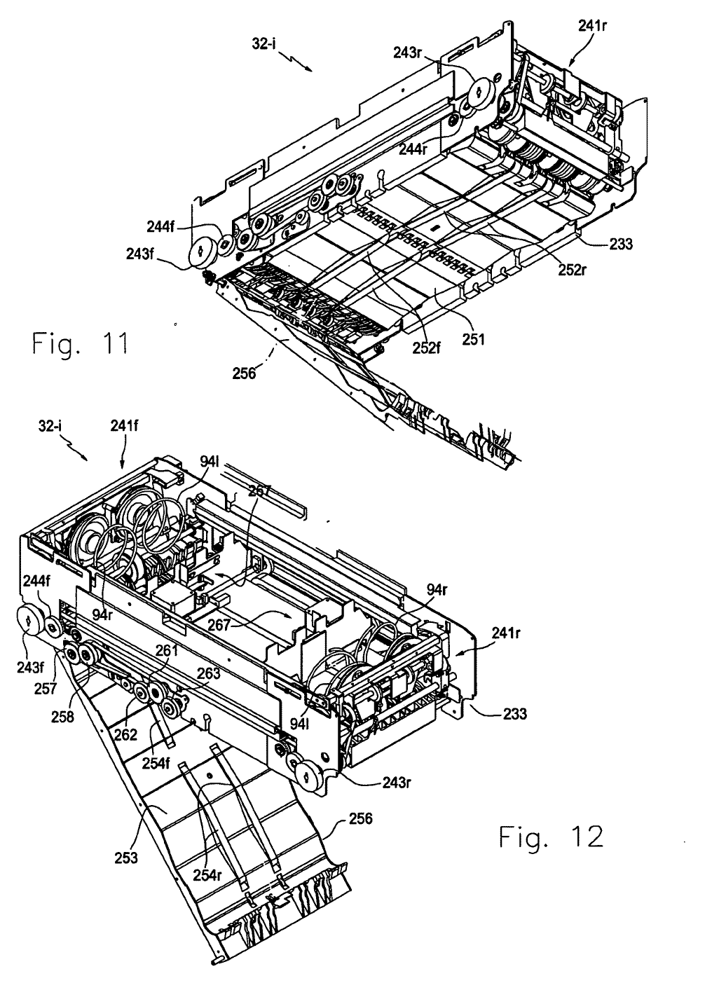

Two configuration taking members 243f and 243r, (FIGS. 3, 11 and 12), similar to the gear 90 of the FIGS. 5 and 7, control the rotation of the spiral elements 94l, 94r, while two introduction-extraction taking members 244f and 244r, similar to the gear 93 of the FIGS. 5 and 7, actuate the introduction-extraction rollers 84 and the separation roller 87. The taking members 243f and 244f are arranged in the front portion of the box 32-i; while the taking members 243r and 244r are arranged in the rear portion, with arrangement inverted with respect to that of the taking members 243f and 244f. In condition of use, the taking members 243f and 244f are engageable by the gears 91 and 92 of the configuration control motor 88 and of the introduction-extraction motor 89. The gear 91 provides to the rotation and the phasing of the spiral elements 94l, 94r of the device 241f and of the shovel elements 116, while the gear 92 provides to the rotations of the separation roller 87 and the introduction-extraction rollers 84 attaining to the stack 238f and to the functions regarding the actuation of the mechanism 100.

The equipment 31 (FIGS. 2 and 3) comprises, at least for the housing of the box 32-i, besides the motors 88 and 89, a configuration control motor 88r and an introduction-extraction motor 89r, similar to the motors 88 and 89. The motors 88r and 89r have respective driving gears 91r, 92r projecting from the wall 67r in proximity of the rear wall and arrangement inverted with respect to the arrangement of the motors 88 and 89 and the gears 91 and 92. In the operational position of the box 32 the, the driving gear 91r of the motor 88r engages the taking member 243r for the rotation of the spiral elements 94l, 94r of the device 241r and of the shovel elements 116 of the terminal sections. In turn, the driving gear 92r engages the taking member 244r for the rotations of the separation roller 87 and the introduction-extraction rollers 84 and for the actuation of the cyclic actuation mechanism 100 which attains to the stack 238r.

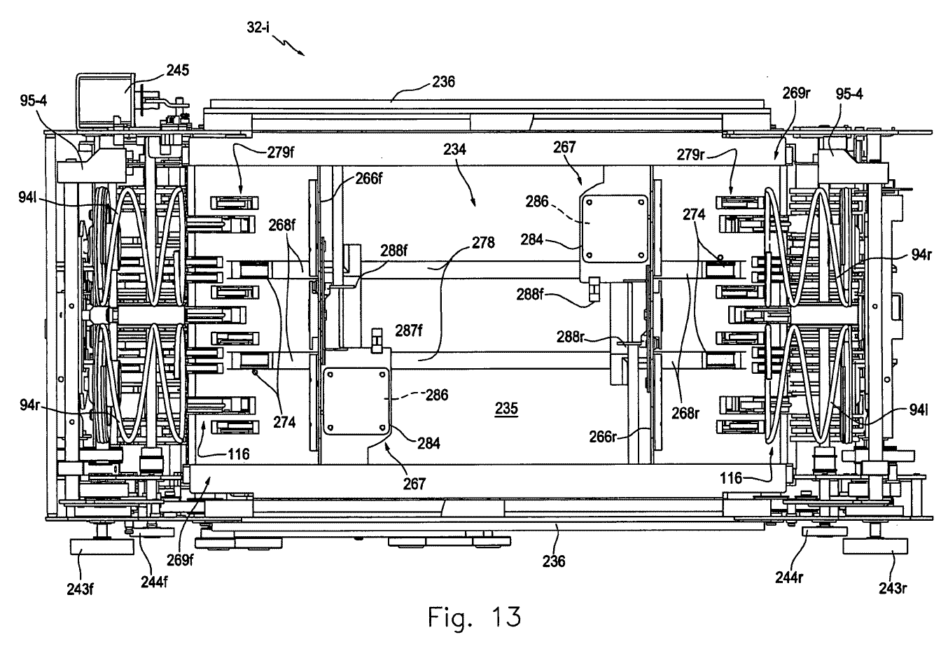

According to the invention, the double box 32-i (FIGS. 3, 4, 6, 8 and 9) provides introduction and extraction of the banknotes of the two stacks 238f 238r through a common input-output passage, constituted, for instance, by the opening 82. The double box further comprises a diverting member 246 for making the banknotes to transit between the input-output passages and the insertion and extraction devices 241f and 241r, and guiding and moving elements 247 for the banknotes arranged between the diverting member 246 and at least one of the insertion and extraction devices 241f and 241r. The diverting member 246 is controllable by the electronic unit 46 of the equipment 31, for instance through an electromagnet 245 (FIG. 13).

In the herein described embodiment, the insertion and extraction device 241f is considered as a reference device with respect to the devices 241f and 241r. The diverting member 246 (FIGS. 4, 6 and 9) is arranged in the front portion of the box 32-i: Thus, the banknotes in movement toward the device 241f or coming from the device 241f a direct path between the diverting member 246 and the introduction-extraction rollers 84. In turn, the guiding and moving elements 247 define an alternative path 249 for the banknotes in transit between the diverting member 246 and the introduction-extraction rollers 84 of the device 241r, in the rear portion of the box 32-i.

In synthesis, the guiding and moving elements 247 (FIGS. 9, 10, 11 and 12) include upper guiding plates 251 and upper belts 252f and 252r mounted on the frame 233 and lower guiding plates 253 and lower belts 254f and 254r mounted on a counter-frame 256, of support for the bottom 231: Two pairs of upper belts 252 and two pairs of lower belts 254 are provided for engaging and shifting the banknotes in transit along the path 249. The lower belts 254 are mounted through idle pulleys of the counter-frame 256, while the upper belts 252 are actuated by the introduction-extraction taking member 244f, in synchronism with the rollers 84, through motor pulleys and a kinematic chain. This chain comprises toothed wheels 257 and 258, a pulley and toothed belt transmission 259, an intermediate toothed wheel 261 and two toothed wheels 262 and 263.

Suitably, the counter-frame 256 is fulcrumed on the frame 233 in proximity of an front end, with possibility of opening for the access to the alternative path 249°, as represented in dots and dashes in FIG. 9, as for the elimination of possible jams of the banknotes processed by the box 32-i, or for maintenance. In turn, the box is mounted on the tray 77 with possibility of turnover of 90° in its position of service, so as to allow the opening of the guiding and moving elements 247, as represented in dots and dashes in FIG. 2.

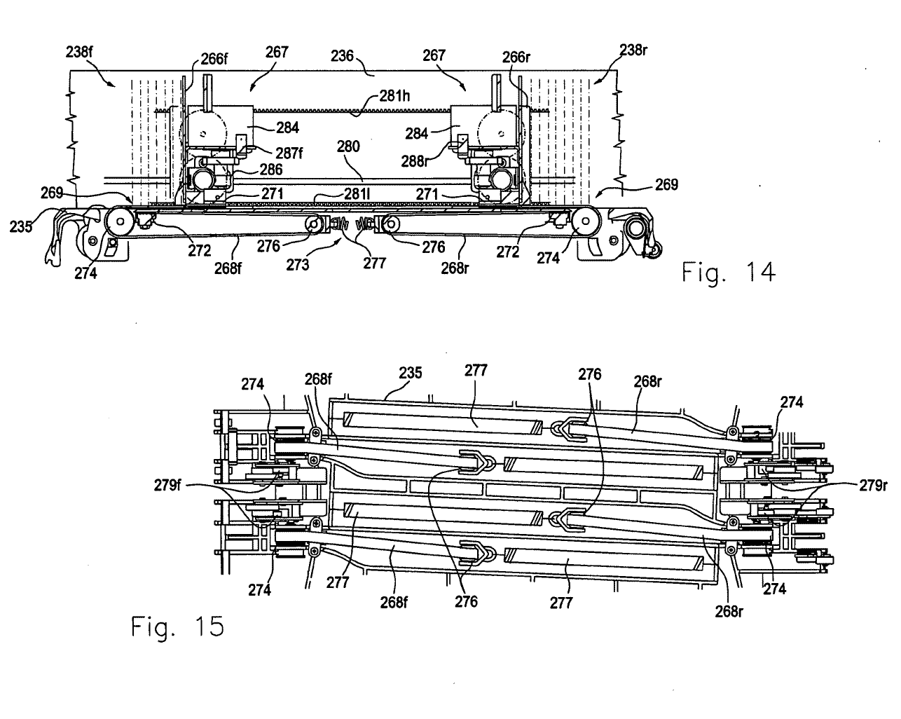

For the moving of the banknote stacks 238f, 238r, the box 32-i includes a pair of pressing elements 266f and 266r (FIGS. 3, 8 and 9) mounted on respective carriages 267 to push in independent way the banknote stacks against the respective insertion and extraction devices 241f, 241r. Two pairs of supporting belts 268f and 268r (FIGS. 13, 14 and 15) project of little with respect to the upper surface of the plate of base 235, with function of support for the lower edges of the stacks 238f and 238r.

Each belt 268f, 268r extends, with a higher branch, from the carriage 267 of the pressing element 266f, 266r up to a window of the plate of base 235 in a terminal area 269f and 269r, as represented in FIG. 12, and returning with a lower branch toward the opposed terminal area 269r and 269f. An end 271 of the belt 268f, 268r is fixed to the carriage; the opposite end 272 is arranged underneath the plate 235, while a restoring member 273 maintains in tension the belt 268f, 268r during the moving of the pressing element 266f, 266r.

Specifically, each belt 268f, 268r is supported between the higher branch and the lower branch by a fixed pulley 274, rotatable in correspondence of the window of the terminal area 269f and 269r. The restoring member 273 includes a movable pulley 276 and a respective spring 277 arranged below the plate of base 235. The pulley 276 engages the lower branch of each belt, while the respective spring 277 is operative on the same pulley 276. The opposite end 272 of each belt 268f, 268r is fixed to the lower portion of the area 269f and 269r, while the spring 277, of rectilinear action, is extended between the pulley 276 and the lower portion of the area 269r, 269f.

With this structure, the belts 268f, and 268r can support and follow, without mutual interferences, the movement of the stacks 238f, 238r of different extensions through the useful space of the seat 234. The corresponding stroke of the movable pulley 276 and the deformation of the spring are the half of the stroke of the carriages 267.

The upper branches of the pairs of belts 268f and the upper branches of the pairs of belts 268r are lodged in a pair of common sliding seats 278 (FIGS. 13 and 14). The seats 278 are obtained in the upper portion of the plate 235 between the windows of the terminal areas 269f and 269r, with axes parallel to the sense of movement of the pressing elements 266f and 267r. In turn, as shown in FIG. 14, the lower branches of the pairs of belts 268f and 268r and the springs 277 are slightly tilted in opposite sense, with respect to the upper branches. Thus, the dimensions in height requested for the two pairs of belts 268f, and 268r are substantially equal to the dimensions of the supporting belts of a box 32 for a single type of banknotes.

Moreover, the movement of the banknote stacks 238f, 238r is made easier by feeding rollers 279f and 279r (FIGS. 10 and 13), projecting of few from the plate of base 235 and interposed between the windows of the areas 269f and 269r and the ends of the plate 235, adjacent to the area of engagement between the rollers 84.

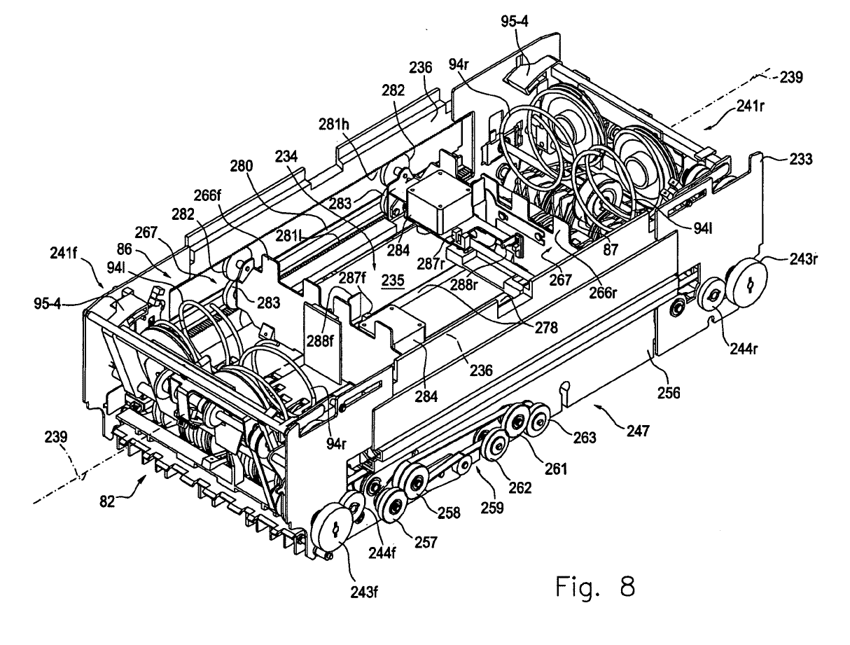

In the double box 32-i, the walls 236 (FIGS. 8, 9 and 12) are provided each one with an upper rack 281h, a lower rack 281l and a guide 280 between the racks, extended parallel to the sense of stacking 239. Each carriage 267 laterally supports, in the rotation, two pairs of identical gears 282 and 283, in mutual engagement and in engagement with the two racks 281h and 281l. The gears 282 and 283 are arranged one above the other, with the gears 283 of each carriage keyed on a common shaft 285. The shaft 285 has ends projecting from the gears 283 and slidably engaged in the guide 280.

A motor 284 is mounted on board of each carriage 267 and actuates the pairs of gears 282 and 283 through a return group 286 and the shaft 285. Thus the carriages 267 advance in view of the rotation of the gears with respect to the racks 281h and 281l. Such structure ensures a balanced moving, devoid of jams, also in the case of banknote stacks 238f, 238r in condition of maximum extension.

Conveniently, the components mounted on the carriages 267 have a specular configuration for minimum dimensions in condition of maximum filling of the banknote seat. In detail, as shown in the plan view of FIG. 13, the motor 284 and the return group 286 for the pressing element 266f are mounted on a side of the carriage 267, while the motor 284 and the group 286 for the pressing element 266r are mounted on the opposite side of the other carriage 267.

The condition of full box for the stack of banknotes 238f, 238r is recognized by sensors 287f, 287r mounted on the respective carriages 267, which are actuatable by corresponding actuating elements 288f, 288r. The active components of the carriages 267 are connected with a connector of the box (not shown) through cables carried in symmetrical way by corresponding chain supports (also not shown) adjacent to the walls 236. Other sensors (not numbered in the figures) are arranged along the paths of the banknotes for verifying the transit thereof in predetermined sections of the guiding and moving elements 247.

A double box with this arrangement can be used in an equipment for the automatic deposit and withdrawal of banknotes, having a general structure with frontal door store safe and vertically overlapped housings for the boxes. The respective store transport mechanism is unique for the two stacks of banknotes of the box and has substantially vertical path, adjacent to the door safe and is easily accessible for inspections and for the elimination of possible jams.

Naturally, the principle of the invention remaining the same, the embodiments and the details of construction of the equipment for the automatic deposit and withdrawal of banknotes and the relative receipting and dispensing boxes can broadly be varied with respect to what has been described and illustrated, by way of non-limitative example, without departing from the ambit of the invention.

1. A receipting and dispensing module for equipments of automatic deposit and withdrawal of banknotes, said module including a banknote seat for storing banknotes with arrangement in superimposition and subdivision in two banknote stacks along a given stacking direction and a couple of insertion and extraction devices for the insertion and the extraction of the banknotes, in which the banknote seat is usable by each one of the banknote stacks and in which the insertion and extraction devices are arranged at the ends of the seat, the said module being characterized by the fact that it comprises:
an input-output passage for the banknotes belonging to the two banknote stacks;
a diverting member controllable for causing the banknotes to selectively transit between the input-output passage and one or the other insertion and extraction device; and
guiding and moving elements for guiding and moving the banknotes between the diverting member and at least one of the insertion and extraction devices.

2. Receipting and dispensing module according to claim 1 characterized by the fact that the diverting member is adjacent to a device of reference of the said insertion and extraction devices, in which the guiding and moving elements define a path of guide for the banknotes in transit with respect to the device of reference and an alternative path for the banknotes in transit with respect to the other device, and in which said guiding and moving elements have active components for moving the banknotes between the diverting member and the other device through said alternative path.

3. Receipting or dispensing module or box according to claim 2 characterized by the fact that the banknotes of the stacks have vertical arrangement with support on a longer edge, in which the banknote seat is delimited in the lower part by a substantially horizontal reference surface and in which said alternative path is extended underneath the reference surface.

4. Receipting and dispensing module according to claim 1 characterized by the fact that said insertion and extraction devices include each one introduction-extraction rollers for moving the entering banknotes and the emerging banknotes, a separation member for stacking the entering banknotes, and a separation roller for separating the stacked banknotes, said module being employable in an equipment comprising a couple of motor members for the motorization of the introduction-extraction rollers and a couple of motor members functional to the separation member of the said devices.

5. Receipting and dispensing module according to claim 4 characterized by the fact that the diverting member is adjacent to a device of reference of the said insertion and extraction devices, in which the guiding and moving elements define a path of guide for the banknotes in transit with respect to the device of reference and an alternative path for the banknotes in transit with respect to the other device, and in which said guiding and moving elements have components active for moving the banknotes between the diverting member and the other device through said alternative path, the active components of the banknote guiding and moving elements being actuated by a motor member of the couple of motor members for the motorization of the introduction-extraction rollers.

6. Receipting or dispensing module or box according to claim 1 characterized by the fact that is employable in an equipment for the automatic deposit and withdrawal of banknotes comprising a transport mechanism for the banknotes, which defines a substantially vertical path, arranged on the front, said module including a front with said input-output passage for receiving the banknotes from the transport mechanism and to address the banknotes toward said transport mechanism, and in which the insertion and extraction devices are arranged on the front and the back of the module, while the diverting member is adjacent to the input-output passage on the front.

7. Receipting and dispensing module according to claim 1 characterized by the fact that said banknote guiding and moving elements comprise operative components mounted with possibility of opening, for the access to the path of the banknotes regarding at least one of the insertion and extraction devices.

8. Receipting and dispensing module according to claim 2 characterized by the fact that said banknote guiding and moving elements include an upper guide body with respective upper movement belts and a lower guide body with respective lower movement belts, in which said active components include said movement belts, and in which the lower guide body is fulcrumed, with possibility of locking, on the upper guide body and has possibility of opening for the access to said alternative path.

9. Receipting or dispensing module or box according to claim 7, characterized by the fact that it is employable in an equipment with housings for respective banknote receipting and dispensing modules and guides for said modules, in which said modules have possibility of sliding in a position of service externally to the housings, said module being mounted on a couple of the said guides with possibility of upsetting, in the position of service, to allow the opening of the banknote guiding and moving elements.

10. Receipting and dispensing module according to claim 1, comprising a couple of pressing elements, for pushing, in independent way, the banknote stacks against the respective insertion and extraction devices; said module being characterized by the fact that it is constituted by a box, in which the stacks have vertical asset and are arranged one behind the other along the direction of stacking, with support of the banknotes on the longer edges; said box including a banknote seat delimited in the lower part by a reference surfaces, and supporting belts for said edges associated with each one of the banknote stacks and projecting a little with respect to the said surface; in which the supporting belts of a given banknote stack extend from the pressing element up to a respective section of the banknote seat and back toward an opposite section, and have each one an end fixed to the respective pressing element and an opposite end arranged underneath the reference surface; and in which respective restoring members are provided for maintaining in tension said belts during the movement of the pressing elements.

11. Receipting and dispensing module according to claim 1 comprising a couple of pressing elements for pushing, in independent way, the banknote stacks against the respective insertion and extraction devices, said module being characterized by the fact that the pressing elements comprise respective carriages, each one with a member of motorization on board, and in which said carriages have specular configuration for minimum dimensions of the banknote seat in condition of maximum storage of the module.

12. Receipting and dispensing module according to claim 1 characterized by the fact that it is employable in an equipment for the automatic deposit and withdrawal of banknotes comprising a store safe with a front door safe, a series of housings for the modules arranged vertically overlapped in the safe, and a store transport mechanism for the banknotes with path substantially vertical adjacent to said door, and in which the input-output passage for the two banknote stacks is arranged on the front of the module.

13. A receipting and dispensing box for an equipment of automatic deposit and withdrawal of banknotes, said box including a banknote seat with arrangement of the banknotes in vertical and ordered on two banknote stacks, and a couple of insertion and extraction devices for the insertion and the extraction of the banknotes with respect to surfaces of insertion and extraction of the banknote stacks; in which the banknote seat has two terminal sections, and in which the two banknote stacks have possibility of use of the banknote seat; the said box being characterized by the fact that the stacks have vertical arrangement, one behind the other, with support of the banknotes on the longer edges, and in which said seat is delimited in the lower part by a reference surface, said box comprising:
a couple of pressing elements for pushing, in independent way, the banknote stacks against the respective insertion and extraction devices; and
supporting belts for each one of the two banknote stacks, projecting a little with respect to said reference surface;
in which the supporting belts of each stack extend from the pressing element to a given section of the reference surface, returning toward the other section, and have each one an end fixed to the pressing element and an opposite end arranged underneath the reference surface, and in which restoring members are provided for maintaining in tension said belts during the movement of the pressing elements.

14. Receipting and dispensing box according to claim 13 characterized by the fact that said reference surface is defined by a plate of base, and in which said plate defines respective seats of slide common for the supporting belts of the two banknote stacks.

15. Receipting and dispensing box according to claim 13 characterized by the fact that it provides a couple of supporting belts for each carriage.

16. Receipting and dispensing box according to claim 13 characterized by the fact that the opposite end of each belt is fixed with respect to the reference surface and in which said restoring members include, underneath the reference surface, a movable pulley interposed between the section of the reference surface and the opposite end, and a rectilinearly acting spring operative on said movable pulley.

17. Receipting and dispensing box according to claim 13 characterized by the fact that, for the return underneath the reference surface, said belts are coupled with respective fixed pulleys, rotatably mounted adjacent to return windows of the reference surface.

18. A receipting and dispensing box for an equipment of automatic deposit and withdrawal of banknotes, said box including a banknote seat with arrangement of the banknotes in vertical, ordered on two banknote stacks and a couple of insertion and extraction devices for the insertion and the extraction of the banknotes, and in which the banknote stacks have possibility of use of a section common of the banknote seat; the said box being characterized by the fact that the banknote stacks are arranged one behind the other, with support of the banknotes on the longer edges, said box further comprising a couple of pressing elements for pushing, in independent way, the banknote stacks against the respective insertion and extraction devices; in which the pressing elements include respective carriages shiftable along the section common and having, on board, motorization members for the moving along the direction of stacking; and in which said carriages have a specular configuration for minimum dimensions in condition of maximum filling of the banknote seat.

19. Receipting and dispensing box according to claim 18, characterized by the fact that the banknote seat it is delimited by two walls, each one having an upper rack and a lower rack parallel to the direction of stacking and two couples of gears mounted on the respective carriages, and in which said gears are actuated by the respective members of motorization and are in mutual engagement and in engagement with said racks.

20. Receipting and dispensing box according to claim 18 characterized by the fact that the condition of full box is recognized by end stroke sensors and end stroke actuators mounted between said carriages.

21. Receipting and dispensing box according to claim 18 characterized by the fact that it includes a plate of base and two couples of supporting belts for said longer edges associated with the two banknote stacks and projecting a little with respect to the said plate of base, in which the couple of supporting belts of a given banknote stack extend from the pressing element to a window of the plate of base, returning toward an opposite window and in which the belts of each couple of supporting belts have each one an end fixed to the carriage and an opposite end arranged underneath the plate of base, the portion of return of each belt being tensioned by restoring members during the movement of the carriages.

22. An equipment for the deposit and the automatic withdrawal of banknotes comprising a series of banknote receipting and dispensing boxes, a store safe with a door safe, a series of housings for said boxes arranged overlapped in the said safe and a store transport mechanism for the banknotes with substantially vertical path adjacent to the door safe and actuatable for the moving of the banknotes with respect to said housings; the said equipment being characterized by the fact that it uses at least one double receipting and dispensing box which stores, in an single seat, banknotes of different typology with subdivision on two banknote stacks arranged one behind the other; in which said double box includes a couple of insertion and extraction devices for the insertion and the extraction of the banknotes with respect to the two banknote stacks; in which said seat has a common section and two terminal sections on the front and the back of the module, and in which the banknote stacks have each one possibility of use of the common section; said double box further comprising a diverting member controllable for making the banknotes to transit between the transport mechanisms and the one or the other of the insertion and extraction devices and guiding and moving elements for moving the banknotes between said diverting member and at least one of the insertion and extraction devices.

23. Equipment according to claim 22 characterized by the fact that the insertion and extraction devices for the double box include each one introduction-extraction rollers for moving the entering banknotes and the emerging banknotes, a separation member for stacking the entering banknotes and a separation roller for separating the stacked banknotes; in which said double box comprises a couple of taking members, functional to the separation members and a couple of transit taking members for the actuation of the introduction-extraction rollers; said equipment comprising a couple of introduction-extraction motors and a couple of configuration motors, and in which the couple of transit taking member is actuatable by the couple of introduction-extraction motors, while the couple of configuration taking members is actuatable by the couple of introduction-extraction motors.

24. Equipment according to claim 22 characterized by the fact that it includes guides for said modules having possibility of sliding in a position of service externally to the housings, in which the guiding and moving elements are arranged in a lower portion of the double box and have possibility of opening for the access to the path of the banknotes regarding at least one of the insertion and extraction devices, and in which said double receipting and dispensing box is mounted on a couple of the said guides with possibility of upsetting in said position of service to allow the opening of the banknote guiding and moving elements.
